(19) United States
(12) Patent Application Publication
(10) Pub. No.: US 2018/0114960 A1
(43) Pub. Date: Apr. 26, 2018

(54) BATTERY PACK

(71) Applicant: YAZAKI CORPORATION, Tokyo (JP)

(72) Inventors: Katsunori Sato, Shizuoka (JP); Takaaki Ezawa, Shizuoka (JP); Motoo Nojima, Shizuoka (JP)

(21) Appl. No.: 15/788,548

(22) Filed: Oct. 19, 2017

(30) Foreign Application Priority Data
Oct. 20, 2016 (JP) 2016-206273

(51) Int. Cl. H01M 2/10; H01M 2/26

(52) U.S. Cl. CPC H01M 2/1077; H01M 2220/20; H01M 2/26

(57) ABSTRACT

A battery pack includes single fixing brackets respectively fixed to an end portion of the battery module in a battery cell stack direction which has a total terminal positive electrode and an end portion of the battery module in the battery cell stack direction which has a total terminal negative electrode connecting and fixing brackets connecting and fixing between end portions adjacent in an arrangement direction in the battery cell stack direction which have no total terminal positive electrode or total terminal negative electrode, a connection mechanism that connects both side ends of each of the adjacent single fixing bracket and connecting and fixing bracket in the arrangement direction to each other so as to be relatively movable in the battery cell stack direction, and an electrical connection member that electrically connects a total positive electrode and a total negative electrode.

### CROSS REFERENCE TO RELATED APPLICATION

This application is based on Japanese Patent Application No. 2016-206273 filed on Oct. 20, 2016, the contents of which are incorporated herein by reference.

### BACKGROUND OF THE INVENTION

### 1. Technical Field

The present specification discloses a battery pack obtained by combining a plurality of battery modules with one another.

### 2. Background Art

A nickel-hydrogen battery, a lithium-ion battery and the like, which are used as a power source for a driving motor of an electric car and a hybrid car, are configured to obtain large power by using a battery module (a battery pack) in which battery cells (unit batteries) are electrically connected to one another by a connection member such as a bus bar in a serial manner or a parallel manner.

Furthermore, in order to obtain larger power, a plurality of battery modules are further connected to one another in a serial manner. For example, see JP-A-2011-171175.

FIG. 7 is a diagram illustrating a battery pack 600 in which two battery modules 501 are received in a battery pack case 560.

In the battery module 501, a plurality of battery cells (not illustrated) juxtaposed on a support body 550 in a thickness direction, a first enclosure 510 and a second enclosure 520 are arranged respectively at both ends in a width direction of the plurality of the battery cells arranged on the support body 550, a pair of third enclosures 540 are arranged at both ends in a thickness direction of the plurality of the battery cells, and a lid 530 is mounted at an upper opening surrounded by these enclosures.

At a positive electrode terminal 502 and a negative electrode terminal 504 adjacent to each other of the battery cell, a bus bar 506 is mounted. The bus bar 506 is welded to the positive electrode terminal 502 and the negative electrode terminal 504 and is thus fixed thereto, thereby electrically connecting between the positive electrode terminal 502 and the negative electrode terminal 504.

At a total positive electrode terminal 502A and a total negative electrode terminal 504A positioned at ends of the positive electrode terminal 502 and the negative electrode terminal 504 serially connected to each other, electrode members 508 used as electrode terminals of the battery module 501 are mounted.

The lid 530 covering the upper portions of the plurality of battery cells includes openings 532 that expose the bus bars 506, openings 534 that expose the electrode members 508, and screw receiving parts 536 into which screw holes of the electrode members 508 are inserted.

When the two battery modules 501 are combined with each other, the electrode member 508 electrically connected to the total positive electrode terminal 502A and the electrode member 508 electrically connected to the total negative electrode terminal 504A are electrically connected to each other by a conductive member 509 serving as an electrical connection member. The conductive member 509 is provided at both ends thereof with openings 509A into which screws are inserted and the openings 509A of the conductive member 509 and the screw holes of the electrode members 508 are positioned so as to be continued, and are fixed by screwing.

The two battery modules 501 are received in the battery pack case 560 such that openings 552 provided in the support body 550 and screw holes 564 of the battery pack case 560 are continued, and the battery modules 501 are positioned by screws inserted into the openings 552 and the screw holes 564 and are thus fixed to the battery pack case 560.

However, as described above, in the battery pack 600 obtained by combining the plurality of battery modules 501 with each other, due to a total length tolerance of the battery modules 501 in which a plurality of battery cells are combined with one another, dimensional deviation occurs in an interval between the total positive electrode terminal 502A and the total negative electrode terminal 504A in the two adjacent battery modules 501 electrically connected to each other by the conductive member 509. In this regard, in the related art, in order to absorb the dimensional deviation to achieve electrically connected state, the hole diameter of the opening 509A of the conductive member 509 is increased by the extent of the dimensional deviation. However, compact connection between the battery modules in a short distance is not possible.

Furthermore, when the number of battery cells is increased for the purpose of high capacity and high output, since the total length tolerance of the battery modules 501 is further increased, even though the hole diameter of the opening 509A in the conductive member 509 is increased, it is not possible to absorb the total length tolerance. Moreover, when detachable connector connection is employed as the connection of the total positive electrode terminal 502A and the total negative electrode terminal 504A between the plurality of battery modules 501, since the amount of tolerance absorbable by the connector is small, it is not possible to absorb the total length tolerance of the battery modules 501. Furthermore, when the total positive electrode terminal 502A and the total negative electrode terminal 504A between the plurality of battery modules 501 are connected to each other by welding with a bus bar, since it is necessary to deform the bus bar, a load to the total positive electrode terminal 502A and the total negative electrode terminal 504A occurs, so that it is not possible to absorb the total length tolerance of the battery modules 501.

The present invention has been made to solve the above-described problem, and an object of the present invention is to provide a battery pack in which a plurality of battery modules are combined with one another and an electrical connection member for electrically connecting between the battery modules can be miniaturized.

### SUMMARY OF THE INVENTION

The aforementioned object according to the present invention is achieved by the following configurations.

(1) According to an aspect of the invention, a battery pack, in which a plurality of battery modules configured by electrically connecting a plurality of stacked battery cells are combined with one another in a mutually parallel arrangement state, includes single fixing brackets respectively fixed to an end portion of the battery module in a battery cell stack direction which has a total terminal positive electrode and an end portion of the battery module in the battery cell stack direction which has a total terminal negative electrode, among the plurality of battery modules, connecting and fixing brackets connecting and fixing between end portions adjacent in an arrangement direction among the end portions of the battery modules in the battery cell stack direction which have no total terminal positive electrode or total terminal negative electrode, a connection mechanism that connects both side ends of each of the adjacent single fixing bracket and connecting and fixing bracket in the arrangement direction to each other so as to be relatively movable only in the battery cell stack direction, and an electrical connection member that electrically connects a total positive electrode and a total negative electrode in each pair of the battery modules adjacent to each other.

According to the battery pack having the aforementioned configuration (1), the single fixing brackets are respectively fixed to the end portion of the battery module with the total terminal positive electrode in the battery cell stack direction and the end portion of the battery module with the total terminal negative electrode in the battery cell stack direction. Furthermore, the connecting and fixing bracket is connected and fixed between end portions of each pair adjacent in the arrangement direction among the end portions of the battery modules in the battery cell stack direction which have no total terminal positive electrode or total terminal negative electrode. In this regard, at both end portions of three or more battery modules in the battery cell stack direction which are arranged in parallel with one another, a plurality of connecting and fixing brackets are arranged in a staggered shape along the arrangement direction. Moreover, the single fixing bracket and the connecting and fixing bracket, which are adjacent to each other, are connected by a connection mechanism so as to be relatively movable only in the battery cell stack direction.

Consequently, the plurality of battery modules combined with one another in the mutually parallel arrangement state are integrally formed with one another by the connecting and fixing brackets, in which both end portions of adjacent each pair in the battery cell stack direction are arranged in a staggered shape along the arrangement direction, and the single fixing bracket, in the state in which the total length tolerance of each of the battery modules is absorbed.

Furthermore, the total positive electrode and the total negative electrode in the battery modules of each pair adjacent in the battery cell stack direction are provided at end portions of the battery modules of each pair, which is connected and fixed to the connecting and fixing brackets, in the battery cell stack direction, so that there is no dimensional deviation at an interval between the total positive electrode and the total negative electrode regardless of the total length tolerance of each battery module. That is, a relative positional relation of the end portions of the battery modules of each pair connected and fixed to the connecting and fixing brackets in the battery cell stack direction is not affected by an influence of the total length tolerance of each battery module.

As a consequence, the electrical connection member, which electrically connects the total positive electrode to the total negative electrode in the battery modules of adjacent each pair, needs not to absorb mounting tolerance among the battery modules of each pair, so that the electrical connection member can be miniaturized.

(2) In the battery pack (1), the electrical connection member is received and held in the connecting and fixing bracket made of an insulating resin material.

According to the battery pack having the aforementioned configuration (2), even when the electrical connection member is formed by a bare conductor such as a bras bar, the electrical connection member needs not to be received in an insulation protector or the like, so that it is possible to discard an insulation member covering the electrical connection member. Therefore, it is possible to improve space efficiency around the electrical connection member.

(3) In the battery pack (1) or (2), the single fixing bracket and the connecting and fixing bracket are fixed to the end portions of the battery modules in the battery cell stack direction via fixing plates that fix the plurality of stacked battery cells by interposing the battery cells therebetween.

According to the battery pack having the aforementioned configuration (3), the single fixing brackets and the connecting and fixing brackets can be easily fixed at the end portions of the battery modules in the battery cell stack direction by screw fixing members such as screw shafts provided to the fixing plates.

In accordance with the battery pack according to the present invention, it is possible to provide a battery pack in which a plurality of battery modules are combined with each other and an electrical connection member for electrically connecting between the battery modules can be miniaturized.

So far, the present invention has been briefly described. Moreover, a mode (hereinafter, referred to as an “embodiment”) for carrying out the invention to be described below is read through with reference to the accompanying drawings, so that details of the present invention will be further clarified.

### BRIEF DESCRIPTION OF DRAWINGS

FIG. 1 is an overall perspective view of a battery pack according to an embodiment of the present invention;

FIG. 2 is a perspective view of main parts in which a battery module is separated from the battery pack illustrated in Fig.

FIGS. 3A and 3B are enlarged perspective views of a connecting and fixing bracket and a single fixing bracket illustrated in FIG. 2, respectively;

FIGS. 4A and 4B are enlarged perspective views of main parts for explaining a connection mechanism that connects adjacent the single fixing bracket and the connecting and fixing bracket to each other;

FIG. 5 is a plan view for explaining a state in which a total length tolerance of each battery module is absorbed in the battery pack illustrated in Fig.

FIGS. 6A and 6B are enlarged perspective views of the main parts for explaining a board receiving part provided to the single fixing bracket in order to receive a voltage monitoring board; and

FIG. 7 is an exploded perspective view for explaining a battery pack in the related art provided with a battery module and a battery pack case for receiving the battery module.

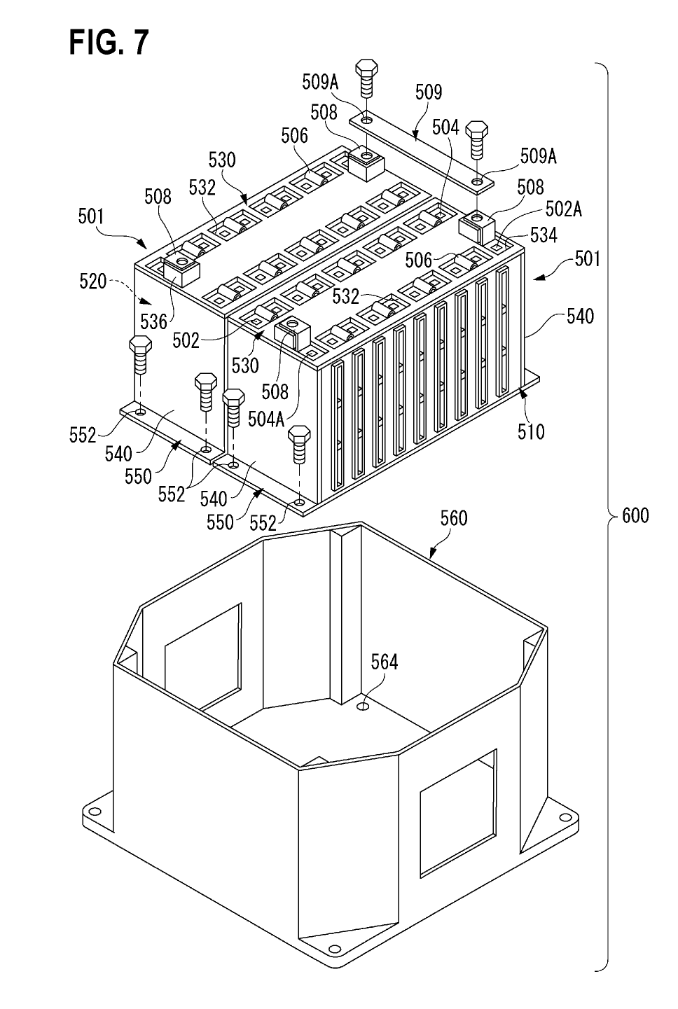

### DETAILED DESCRIPTION OF EMBODIMENTS

Hereinafter, an embodiment according to the present invention will be described with reference to the drawings.

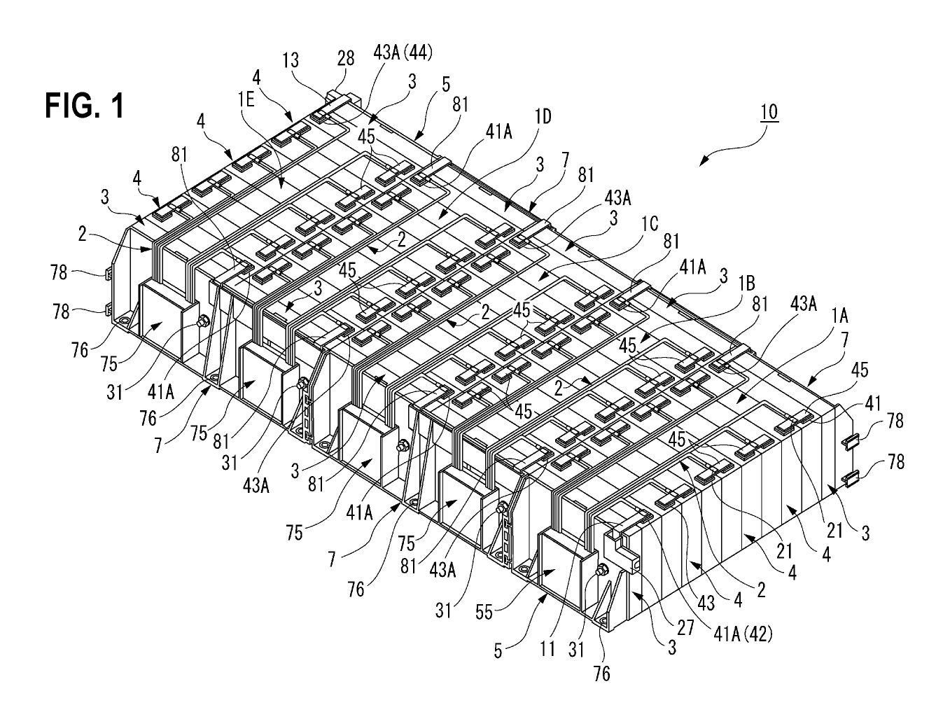

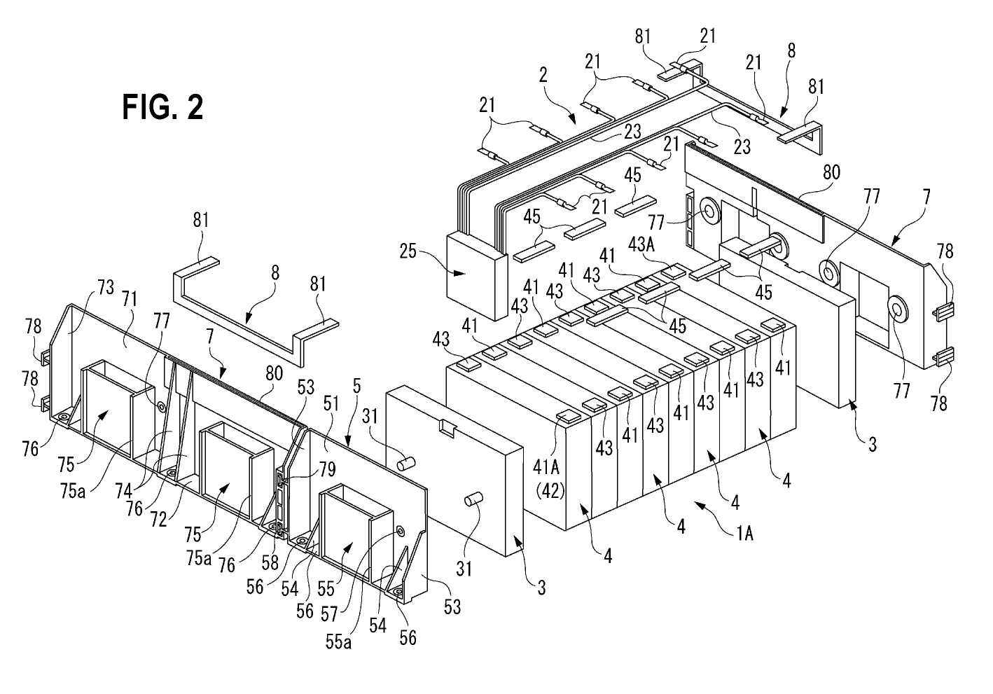

As illustrated in FIGS. 1 and 2, a battery pack 10 according to an embodiment of the present invention is a battery pack in which a plurality of (five in the present embodiment) battery modules 1A to 1E are combined with one another in a mutually parallel arrangement state. The battery pack 10, for example, has an upper surface covered by an insulating cover (not illustrated), and is received in a receiving case (not illustrated) and is fixed thereto. In addition, the battery pack of the present invention is not limited to the configuration in which the five battery modules are combined with one another, and employs one battery module as a minimum unit module, thereby providing a battery pack capable of increasing/decreasing the number of battery modules to be combined in correspondence with a plurality of product variations (required power).

As illustrated in FIG. 2, each of the battery modules 1A to 1F, includes a plurality of stacked battery cells 4, a pair of fixing plates 3 for fixing the stacked battery cells 4 by interposing the battery cells therebetween, an inter-cell bus bar 45 for electrically connecting between adjacent battery cells 4, and a battery voltage measuring unit 2 for detecting the voltages of the battery cells 4.

The battery cells 4 are juxtaposed in a horizontal direction in a plural number (9 in the illustrated example). In the present embodiment, each of the battery cells 4 is formed in an approximately rectangular parallelepiped shape having a small width. As the battery cell 4, it is possible to use a battery such as a nickel-hydrogen battery and a lithium-ion battery.

Each battery cell 4 is provided on an upper surface at one end and the other end thereof with a pair of positive electrode terminal 41 and negative electrode terminal 43 respectively, serving as a plate electrode. The positive electrode terminal 41 is electrically connected to a positive electrode plate (a current collector plate) serving as a power generation element in the battery body. The negative electrode terminal 43 is electrically connected to a negative electrode plate (a current collector plate) serving as the power generation element in the battery body. In the battery cells 4, the positive electrode terminal 41 and the negative electrode terminal 43 are arranged while alternately changing their directions so as to be adjacent to each other, and in the state where the plurality of battery cells 4 are interposed between the pair of fixing plates 3, the battery cells 4 are restricted by a restrictive band and the like (not illustrated) and are respectively integrated as the battery modules 1A to 1E. In addition, between the adjacent battery cells 4, a member (a spacer) for insulating the battery cells 4 may be provided.

The fixing plate 3 is a flat rectangular parallelepiped having a pressing surface which has an approximately the same shape as that of a side surface in a battery cell stack direction of the battery cell 4, and a pair of screw shafts 31 protrude from a side surface opposite to the pressing surface.

The plurality of stacked battery cells 4 are electrically connected to one another in a serial manner. That is, at the upper surfaces of the battery cells 4, the inter-cell bus bars 45 are arranged. Each inter-cell bus bar 45 electrically connects the two battery cells 4, which are adjacent to each other in the battery cell stack direction (the right and left direction of FIG. 2), in a serial manner.

The inter-cell bus bar 45 is connected to the battery voltage measuring unit 2 for detecting the voltages of the battery cells 4 connected by the inter-cell bus bars 45. For example, the inter-cell bus bars 45 and voltage detection lines 23 are electrically connected to each other via voltage detection terminals 21 formed separately from the inter-cell bus bars 45 by performing punching, bending and the like for a conductor flat plate. Crimping parts of the voltage detection terminals 21 are crimped to a conductor of the voltage detection line 23. Then, the voltage detection terminals 21 are bonded to the inter-cell bus bars 45 by welding and the like, so that the voltage detection terminals 21 are respectively fixed to the battery modules 1A to 1E.

The other end of each voltage detection line 23 having one end bonded to the inter-cell bus bar 45 is connected to a battery monitoring board 25. The battery monitoring board 25 is an electronic parts for detecting the voltage of each battery cell 4 of each of the battery modules 1A to 1E and controlling charge, discharge and the like of each battery cell 4 on the basis of the detected voltage value, and has a microcomputer and a detection circuit for detecting the voltage, current, temperature and the like of each battery cell 4.

Moreover, as illustrated in FIG. 1, two single fixing brackets 5 and four connecting and fixing brackets 7 are respectively fixed to the end portions of the five battery modules 1A to 1E, in which the plurality of battery cells 4 are electrically connected to one another in a serial manner, in the battery cell stack direction, so that the battery modules 1A to 1E are integrally combined with one another in the mutually parallel arrangement state to constitute the battery pack 10.

The single fixing brackets 5 are respectively fixed to the end portion of the battery module 1A in the battery cell stack direction which has a total terminal positive electrode 42 total positive electrode 41A in the battery module 1A of the most upstream side (the right side of FIG. 1)) of the battery pack 10, and the end portion of the battery module 1E in the battery cell stack direction which has a total terminal negative electrode 44 (a total negative electrode 43A in the battery module 1E of the most downstream side (the left side of FIG. 1)) of the battery pack 10, among the five battery modules 1A to 1E.

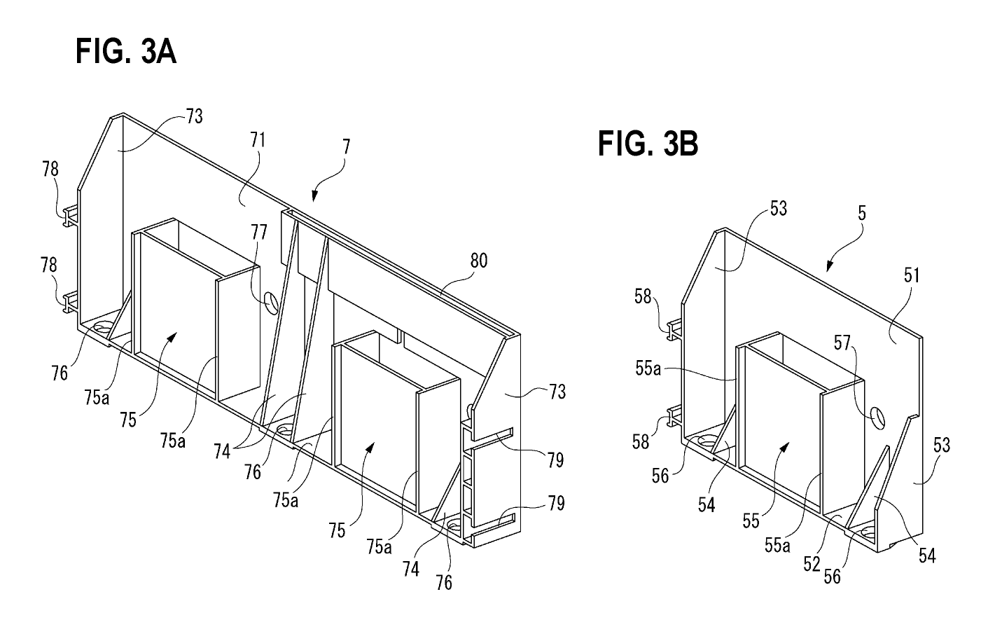

As illustrated in FIG. 3B, the single fixing bracket 5 includes a bracket body 51 having a rectangular plate shape, a mounting leg 52 vertically provided at the lower end edge of the bracket body 51, sidewalls 53 vertically provided at both side edges of the bracket body 51 in the arrangement direction, and a board receiving part 55 provided to the bracket body 51. The single fixing bracket 5 is made of an insulating resin material, has a box shape in which three sides of the bracket body 51 are surrounded with the mounting leg 52 and the sidewalls 53, and forms a high strength structure in which the bracket body 51 has reinforcing ribs 54,

The bracket body 51 is a flat plate having an external appearance which is approximately the same as that of a side surface of the fixing plate 3 in the battery cell stack direction, and the mounting leg 52 and the sidewalls 53 are vertically provided at an outer surface opposite to an inner surface facing the fixing plate 3. The bracket body 51 is formed with a pair of screw insertion holes 57. Then, nuts are fastened to the screw shafts 31 of the fixing plate 3 inserted through the screw insertion holes 57, so that the single fixing bracket 5 can be fixed to the fixing plate 3.

The mounting leg 52 is provided with mounting holes 56 for fixing the single fixing bracket 5 to the receiving case (not illustrated) by screw fastening. The mounting holes 56 are opened in an oval shape such that fixed positions of the single fixing bracket 5 can be adjusted with respect to bolts vertically provided to the receiving case.

The board receiving part 55 defines a rectangular parallelepiped receiving space across the bracket body 51 and the mounting leg 52, and the battery monitoring board 25 of the battery voltage measuring unit 2 is received and held therein. The board receiving part 55 is provided at the outer surface thereof with ribs 55a for strength improvement, so that the battery monitoring board 25 is protected from an impact at the time of a vehicle collision and the like.

Moreover, one (the left side of FIG. 3B) of the sidewalls 53 is provided with dovetail tenons 58 configuring a dovetail joint structure, which is a connection mechanism, together with dovetail holes 79 of the connecting and fixing bracket 7 to be described below.

The connecting and fixing bracket 7 is connected and fixed between end portions adjacent in the arrangement direction among the end portions of the battery modules 1A to 1E in the battery cell stack direction which have no total terminal positive electrode 42 or total terminal negative electrode 44. That is, among the five battery modules 1A to 1E combined with one another in the mutually parallel arrangement state, at the end portions of the battery modules 1A to 1E in the battery cell stack direction to which the single fixing brackets 5 are not fixed, the four connecting and fixing brackets 7 are arranged in a staggered shape along the arrangement direction.

As illustrated in FIG. 3A, the connecting and fixing bracket 7 includes a bracket body 71 having a rectangular plate shape, a mounting leg 72 vertically provided at the lower end edge of the bracket body 71, sidewalls 73 vertically provided at both side edges of the bracket body 71 in the arrangement direction, and a pair of board receiving parts 75 provided to the bracket body 71. The connecting and fixing bracket 7 is made of an insulating resin material, has a box shape in which three sides of the bracket body 71 are surrounded with the mounting leg 72 and the sidewalls 73, and forms a high strength structure in which the bracket body 71 has reinforcing ribs 74.

The bracket body 71 is a flat plate having an external appearance which is obtained by transversely and doubly arranging the side surface of the fixing plate 3 in the battery cell stack direction, and the mounting leg 72 and the sidewalls 73 are vertically provided at an outer surface opposite to the inner surface facing the fixing plate 3. The bracket body 71 is formed with two pairs of screw insertion holes 77.

Then, nuts are fastened to the screw shafts 31 inserted through the screw insertion holes 77 of the two fixing plates 3, which are adjacent to each other in the arrangement direction, so that the connecting and fixing bracket 7 can be fixed so as to connect the two fixing plates 3 transversely arranged.

Furthermore, the bracket body 71 is provided at an upper end edge thereof with a bus bar receiving part 80 for receiving and holding an inter-module bus bar 8 to be described later.

The mounting leg 72 is provided with mounting holes 76 for fixing the connecting and fixing bracket 7 to the receiving case (not illustrated) by screw fastening. The mounting holes 76 are opened in an oval shape such that fixed positions of the connecting and fixing bracket 7 can be adjusted with respect to bolts vertically provided to the receiving case.

The board receiving part 75 defines a rectangular parallelepiped receiving space across the bracket body 71 and the mounting leg 72, and the battery monitoring board 25 of the battery voltage measuring unit 2 is received and held therein. The board receiving part 75 is provided at an outer surface thereof with rib 75a for strength improvement, so that the battery monitoring board 25 is protected from an impact at the time of a vehicle collision and the like.

Moreover, one (the left side of FIG. 3A) of the sidewalls 73 is provided with dovetail tenons 78 configuring a dovetail joint structure, which is a connection mechanism, and the other one (the right side of FIG. 3A) of the sidewalls 73 is provided with dovetail holes 79 configuring the dovetail joint structure.

The five battery modules 1A to 1E are arranged while alternately changing their directions such that the total positive electrode 41A and the total negative electrode 43A adjacent to each other in the arrangement direction (the right and left direction of FIG. 1) serve as end portions in the same battery cell stack direction, and are combined with one another in the mutually parallel arrangement state.

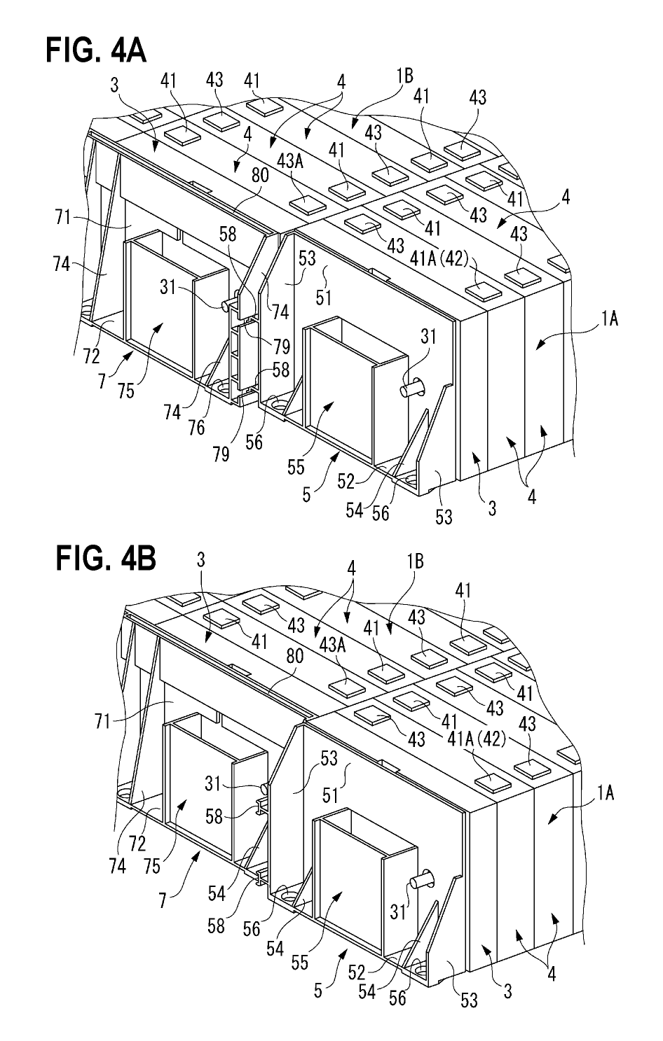

In this case, as illustrated in FIGS. 4A and 4B, both side ends of the adjacent single fixing bracket 5 and connecting and fixing bracket 7 in the arrangement direction are connected to each other by the dovetail joint structure provided with the dovetail tenons 58 and 78 and the dovetail holes 79 which connect the single fixing bracket and the connecting and fixing bracket 7 so as to be relatively movable only in the battery cell stack direction (the right and left direction of FIGS. 4A and 4B).

That is, for example, as illustrated in FIG. 4A, when the total length of the battery module 1A with the stacked battery cells 4 is shorter than that of the battery module 113 the connecting and fixing bracket 7, which is connected and fixed to an end portion (the right end portion of FIG. 1) of the battery module 1A (which has no total terminal positive electrode 42) in the battery cell stack direction and the other end portion (the left end portion of FIG. 1) of the battery module 1B in the battery cell stack direction, can protrude toward the battery cell stack direction while maintaining the connection state of the arrangement direction with respect to the single fixing bracket 5 fixed to the end portion (the left end portion of FIG. 1) of the battery module 1A (which has the total terminal positive electrode 42) in the battery cell stack direction, wherein the one end portion of the battery module 1B in the battery cell stack direction is connected and fixed by the connecting and fixing bracket 7.

Furthermore, for example, as illustrated in FIG. 4B, when the total length of the battery module 1A with the stacked battery cells 4 is longer than that of the battery module 1B, the single fixing bracket 5, which is fixed to the one end portion (the right end portion of FIG. 1) of the battery module 1B in the battery cell stack direction and the other end portion (the left end portion of FIG. 1) of the battery module 1A in the battery cell stack direction, can protrude toward the battery cell stack direction while maintaining the connection state of the arrangement direction with respect to the connecting and fixing bracket 7 fixed to the other end portion of the battery module 1B in the battery cell stack direction, wherein the end portion of the battery module 1A (which has no total terminal positive electrode 42) in the battery cell stack direction is connected and fixed by the connecting and fixing bracket 7.

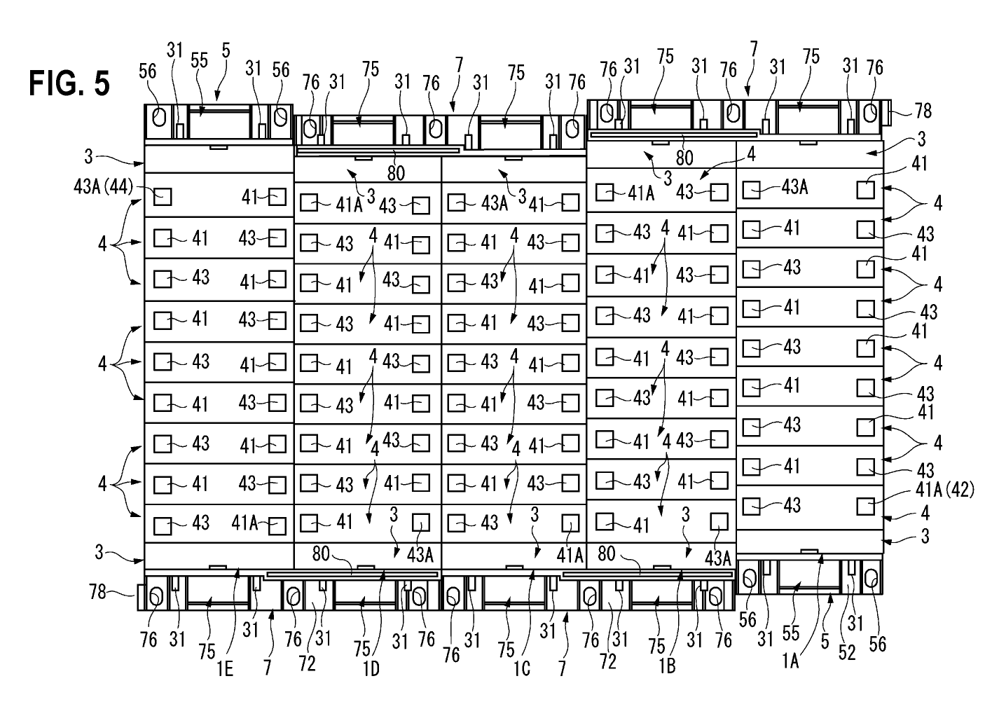

Accordingly, as illustrated in FIG. 5, the five battery modules 1A to 1E combined with one another in the mutually parallel arrangement state can be integrally formed with one another as the battery pack 10 by the connecting and fixing brackets 7, in which both end portions of adjacent each pair in the battery cell stack direction are arranged in the staggered shape along the arrangement direction, and the single fixing bracket 5, in the state in which the total length tolerance of each of the battery modules 1A to 1E is absorbed.

Moreover, the five battery modules 1A 1o 1E combined with one another in the mutually parallel arrangement state are electrically connected to one another in a serial manner. That is, the inter-module bus bar 8 is arranged between end portions adjacent in the arrangement direction among the end portions of the battery modules 1A to 1E in the battery cell stack direction. The inter-module bus bar 8 is an electrical connection member that electrically connects the total positive electrode 41A and total negative electrode 43A to each other in a serial manner in the two battery modules among the battery modules 1A to 1E which are adjacent to each other in the arrangement direction.

The inter-module bus bar 8 is a bus bar formed by a conductive metal plate and having an approximately U shape, wherein one electrical connection end portion 81, for example, is connected to the total negative electrode 43A in the battery module 1A of the most upstream side (the right side of FIG. 1) and the other electrical connection end portion 81 is connected to the total positive electrode 41A in the battery module 1B of the downstream side. The inter-module bus bar 8, except for the electrical connection end portions 81, is inserted into the bus bar receiving part 80 provided to the upper end edge of the bracket body 71, and thus is received in and held by the connecting and fixing bracket 7.

Furthermore, as illustrated in FIG. 1, one end of a bus bar 11 formed by a conductive metal plate and having an approximately L shape is connected to the total terminal positive electrode 42 of the battery pack 10 and a connector 27 is connected to the other end of the bus bar 11. Furthermore, one end of a bus bar 13 formed by a conductive metal plate and having an approximately L shape is connected to the total terminal negative electrode 44 of the battery pack 10 and a connector 28 is connected to the other end of the bus bar 13. Accordingly, by the connector 27 and the connector DC output is obtained from the battery pack 10.

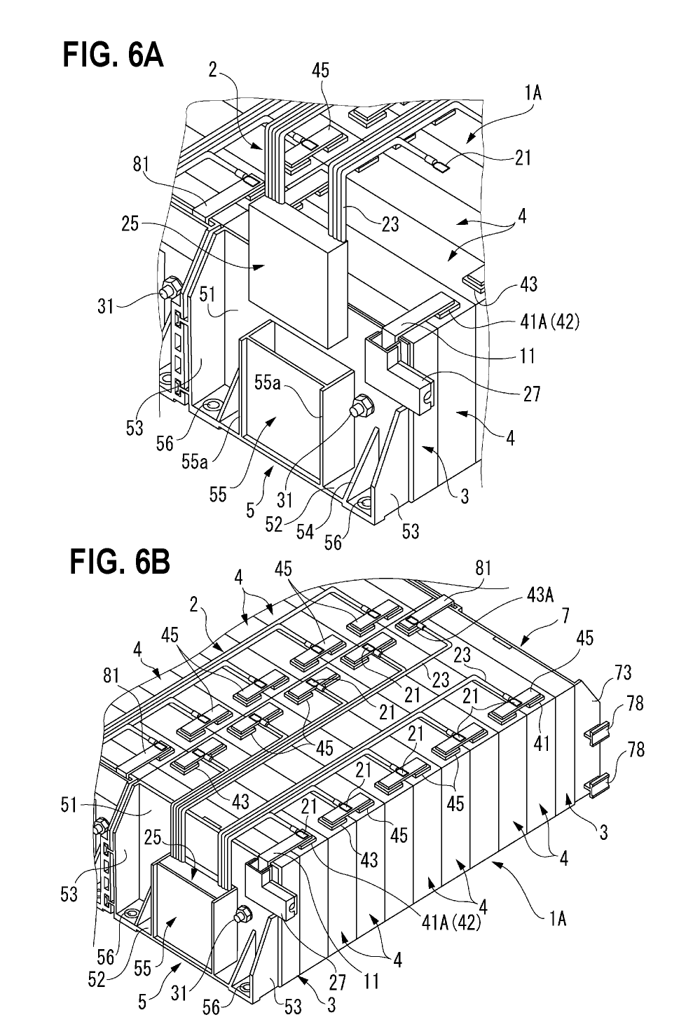

After the five battery modules 1A to 1E are integrally formed with one another as the battery pack 10, the battery voltage measuring unit 2 is connected to each of the battery modules 1A to 1E. That is, as illustrated in FIGS. 6A and 6B, the voltage detection terminals 21 are respectively bonded to the inter-cell bus bars 45, so that the battery monitoring board 25 is received in the board receiving part 55 of the single fixing bracket 5 and the board receiving part 75 of the connecting and fixing bracket 7 arranged at a corresponding one end portion (the left side of FIG. 1) in the battery cell stack direction.

Therefore, the battery monitoring board 25 is received and held in the board receiving part 55 and the board receiving part 75 which are respectively provided with the ribs 55a and the ribs 75a for strength improvement and are respectively integrally formed in the single fixing bracket 5 and the connecting and fixing bracket 7 forming a high strength structure, so that the battery monitoring board 25 can be reliably protected from an impact at the time of a vehicle collision and the like.

Furthermore, the battery voltage measuring unit 2 is connected to each of the battery modules 1A to 1E and the battery monitoring board 25 monitors the voltages of the battery cells 4, which belong to each of the battery modules 1A to 1E, for each of the battery modules 1A to 1E. The battery monitoring board 25 installed at each of the battery modules 1A to 1E is connected to a high-order battery ECU (not illustrated) via a communication line. Consequently, the battery pack 10 includes five battery voltage measuring units 2. That is, it is desired to include a plurality of battery voltage measuring units in accordance with the number of battery modules constituting the battery pack.

According to such a configuration, since a total voltage of the five battery modules 1A to 1E is set to be equal to or less than a safety voltage (for example, a range of 50 V to 70 V preferably, about 60 V), the five battery voltage measuring units 2 can be respectively mounted at the five battery modules 1A to 1E set to have the safety voltage or less. Therefore, since a maximum voltage detected in the five battery voltage measuring units 2 corresponds to a total voltage of the battery cells 4, which belong to each of the battery modules 1A to 1E to be monitored, it is possible to suppress the detected voltage to be equal to or less than the safety voltage even though the detected voltage is maximum.

Consequently, even when predetermined work is performed for the battery voltage measuring units 2, the work can be performed within the safety voltage. That is, even when the number of battery cells constituting the battery pack is large, a plurality of battery modules suppressed to be equal to or less than the safety voltage are provided and the battery voltage measuring unit is provided to each of the battery modules as the present embodiment, so that it is possible to ensure safety at the time of work for the battery voltage measuring units.

For example, even in the case of a battery pack in which one stack includes a dozen or more or several tens of battery cells, exchange work when an error occurs in the battery voltage measuring units is performed for individual battery voltage measuring unit, so that it is possible to reliably ensure safety at the time of work. Furthermore, since it is sufficient if only the individual battery voltage measuring unit with the error is exchanged and it is not necessary to exchange all the battery voltage measuring units, it is also possible to improve workability.

Next, an operation of the battery pack 10 having the aforementioned configuration will be described.

In the battery pack 10 according to the present embodiment, the single fixing brackets 5 are respectively fixed to an end portion (the right lower end portion of FIG. 5) of the battery module 1A with the total terminal positive electrode 42 in the battery cell stack direction and an end portion (the left upper end portion of FIG. 5) of the battery module 1E with the total terminal negative electrode 44 in the battery cell stack direction. Furthermore, the connecting and fixing bracket 7 is connected and fixed between end portions of each pair adjacent in the arrangement direction (the right and left direction of FIG. 5) among the end portions (end portions in the up and down direction of FIG. 5) of the battery modules 1A to 1E in the battery cell stack direction which have no total terminal positive electrode 42 or total terminal negative electrode 44.

Therefore, at both end portions of the five battery modules 1A to 1E in the battery cell stack direction which are arranged in parallel with one another, the four connecting and fixing brackets 7 are arranged in a staggered shape along the arrangement direction. Moreover, the adjacent single fixing bracket 5 and connecting and fixing bracket 7 are connected by the dovetail joint structure (a connection mechanism) provided with the dovetail tenons 58 and 78 and the dovetail holes 79 so as to be relatively movable only in the battery cell stack direction (the up and down direction of FIG. 5).

Consequently, the five battery modules 1A to 1E combined with one another in the mutually parallel arrangement state are integrally formed with one another by the connecting and fixing brackets 7, in which both end portions of adjacent each pair in the battery cell stack direction are arranged in the staggered shape along the arrangement direction, and the single fixing bracket 5, in the state in which the total length tolerance of each of the battery modules 1A to 1E is absorbed.

Furthermore, the total positive electrode 41A and the total negative electrode 43A in each pair of the battery modules (1A and 1B), (1B and 1C), (1C and 1D), and (1D and 1E) adjacent in the battery cell stack direction are provided at end portions of the pair of the battery modules (1A and 1B), (1B and 1C), (1C and 1D), and (1D and 1E) which is connected and fixed to the connecting and fixing brackets 7, so that there is no dimensional deviation at an interval between the total positive electrode 41A and the total negative electrode 43A regardless of the total length tolerance of each of the battery modules 1A to 1E. That is, a relative positional relation of the end portions of the pair of the battery modules (1A and 1B), (1B and 1C), (1C and 1D), and (1D and 1E) in the battery cell stack direction which is connected and fixed to the connecting and fixing brackets 7, is not affected by an influence of the total length tolerance of each of the battery modules 1A to 1E.

As a consequence, the inter-module bus bar 8, which electrically connects the total positive electrode 41A and the total negative electrode 43A in the each pair of the battery modules (1A and 1B), (1B and 1C), (1C and 1D), or (1D and 1E) adjacent to each other, needs not to absorb mounting tolerance among the battery modules of each pair, so that the inter-module bus bar 8 can be miniaturized.

Furthermore, in the battery pack 10 according to the present embodiment, the inter-module bus bar 8 is received and held in the bus bar receiving part 80 of the connecting and fixing bracket 7 made of an insulating resin material.

Therefore, the inter-module bus bar 8, which is a bare conductor, needs not to be received in an insulation protector or the like, so that it is possible to discard an insulation member covering the inter-module bus bar 8. Therefore, it is possible to improve space efficiency around the inter-module buy bar 8.

Moreover, in the battery pack 10 according to the present embodiment, the single fixing brackets 5 and the connecting and fixing brackets 7 are fixed at the end portions of the battery modules 1A to 1E in the battery cell stack direction via a pair of fixing plates 3 for fixing a plurality of stacked battery cells 4 by interposing the battery cells therebetween.

Therefore, the single fixing brackets 5 and the connecting and fixing brackets 7 can be easily fixed at the end portions of the battery modules 1A to 1E in the battery cell stack direction by the screw shafts 31 provided to the fixing plates 3 and serving as screw fixing members.

So far, the aforementioned embodiment has been described with reference to the drawings; however, it goes without saying that the present invention is not limited to such an example. It is apparent that a person having an ordinary skill in the related art can arrive at various modification examples or corrected examples within the category described in claims, and it is understood that the modification examples or the corrected examples are naturally included in the technical range of the present invention.

For example, in the aforementioned configuration example, the case in which the electrode is a plate electrode has been described as an example; however, the electrode may be a pole. Consequently, connection between the inter-cell bus bar 45 and the electrode is not limited to welding and the like and may be obtained by screw fastening and the like.

Consequently, in accordance with the battery pack 10 according to the present embodiment, a plurality of battery modules 1A to 1E are combined with one another, so that it is possible to provide a battery pack in which it is possible to miniaturize the inter-module bus bar 8 that electrically connects between the battery modules.

Hereinafter, characteristics of the aforementioned embodiment of the battery pack according to the present invention will be simply summarized as follows.

[1] The battery pack (10), in which the plurality of battery modules (1A to 1E) configured by electrically connecting the plurality of stacked battery cells (4) are combined with one another in a mutually parallel arrangement state, includes the single fixing brackets (5) respectively fixed to the end portion of the battery module (1A) in a battery cell stack direction which has the total terminal positive electrode (42) and the end portion of the battery module (1E) in the battery cell stack direction which has the total terminal negative electrode (44), among the plurality of battery modules (1A to 1E),

the connecting and fixing brackets (7) connecting and fixing between end portions adjacent in an arrangement direction among the end portions of the battery modules (1A to 1E) in the battery cell stack direction which have no total terminal positive electrode or total terminal negative electrode,

the connection mechanism (the dovetail tenons 58 and 78 and the dovetail holes 79) that connects both side ends of each of the adjacent single fixing bracket and connecting and fixing bracket in the arrangement direction to each other so as to be relatively movable only in the battery cell stack direction; and

the electrical connection member (the inter-module bus bar 8) that electrically connects the total positive electrode (41A) and the total negative electrode (43A) in the each pair of the battery modules (1A and 1B), (1B and 1C), (1C and 1D), or (1D and 1E) adjacent to each other.

[2] The battery pack (10) according to the aforementioned [1], wherein the electrical connection member (the inter-module bus bar 8) is received and held in the connecting and fixing bracket (7) made of an insulating resin material.

[3] The battery pack (10) according to the aforementioned [1] or [2], wherein the single fixing brackets (5) and the connecting and fixing brackets (7) are fixed to the end portions of the battery modules (1A to 1E) in the battery cell stack direction via the fixing plates (3) that fix the plurality of stacked battery cells (4) by interposing the battery cells therebetween.

What is claimed is:

1. A battery pack, in which a plurality of battery modules configured by electrically connecting a plurality of stacked battery cells are combined with one another in a mutually parallel arrangement state, comprising:
single fixing brackets respectively fixed to an end portion of the battery module in a battery cell stack direction which has a total terminal positive electrode and an end portion of the battery module in the battery cell stack direction which has a total terminal negative electrode, among the plurality of battery modules;
connecting and fixing brackets connecting and fixing between end portions adjacent in an arrangement direction among the end portions of the battery modules in the battery cell stack direction which have no total terminal positive electrode or total terminal negative electrode;
a connection mechanism that connects both side ends of each of the adjacent single fixing bracket and connecting and fixing bracket in the arrangement direction to each other so as to be relatively movable only in the battery cell stack direction; and
an electrical connection member that electrically connects a total positive electrode and a total negative electrode in each pair of the battery modules adjacent to each other.

2. The battery pack according to claim 1, wherein the electrical connection member is received and held in the connecting and fixing bracket made of an insulating resin material.

3. The battery pack according to claim 1, wherein the single fixing bracket and the connecting and fixing bracket are fixed to the end portions of the battery modules in the battery cell stack direction via fixing plates that fix the plurality of stacked battery cells by interposing the battery cells therebetween.

4. The battery pack according to claim 2, wherein the single fixing bracket and the connecting and fixing bracket are fixed to the end portions of the battery modules in the battery cell stack direction via fixing plates that fix the plurality of stacked battery cells by interposing the battery cells therebetween.
